(19) United States
(12) Patent Application Publication
(10) Pub. No.: US 2014/0036143 A1
(43) Pub. Date: Feb. 6, 2014

(54) IMAGE ACQUISITION APPARATUS AND IMAGE ACQUISITION SYSTEM

(71) Applicant: CANON KABUSHIKI KAISHA, Tokyo (JP)

(72) Inventors: Yuji Katashiba, Kawasaki-shi (JP); Kazuhiko Kajiyama, Utsunomiya-shi (JP); Hirofumi Fujii, Toyono-gun (JP)

(21) Appl. No.: 13/954,250

(22) Filed: Jul. 30, 2013

(30) Foreign Application Priority Data
Jul. 31, 2012 (JP) 2012-169758

(51) Int. Cl. H04N 5/225

(52) U.S. Cl. CPC H04N 5/2254
USPC 348/369

(57) ABSTRACT

An image acquisition apparatus includes an imaging optical system configured to image an object, a reimaging optical system configured to reimage the object imaged by the imaging optical system, a reflecting member disposed in an optical path between the imaging optical system and the reimaging optical system, an image sensor configured to capture an image of the object reimaged by the reimaging optical system, and to output the image, a first driving unit configured to change a tilt of the reflecting member relative to an optical axis of the imaging optical system, and a correction unit configured to correct a positional deviation of the image in a rotational direction, wherein the positional deviation of the image is generated according to a change in the tilt of the reflecting member.

### BACKGROUND OF THE INVENTION

1. Field of the Invention

The present invention relates to an image acquisition apparatus, which can be effectively used as, for example, an image acquisition system that acquires image data of a pathological sample.

2. Description of the Related Art

In recent pathological examinations, people are paying attention to an image acquisition system that captures an image of a pathological specimen (a sample) to acquire image data thereof by an image acquisition apparatus, and displays the acquired image data on a display to allow observation thereof. According to the image acquisition system, for example, the image data of the sample can be observed by a plurality of people simultaneously, and shared with pathologists at distant locations.

When observing a large sample that cannot be contained within the field of view of an objective lens, the image acquisition apparatus can acquire an image of the whole sample by capturing an image of the sample a plurality of times while moving the sample horizontally (step image capturing), or by capturing an image of the sample while scanning the sample. Further, observation of a sample requires an objective optical system having a high resolving power in a visible light range. However, increasing the numerical aperture (NA) of the objective optical system to attain a high resolving power leads to a reduction in the depth of focus. Therefore, that results in generation of a defocused portion in a part of a sample if the sample has an uneven surface in the depth direction, making acquisition of an excellent image of the whole sample impossible.

Japanese Patent Application Laid-Open No. 2007-208775 discusses an image capturing apparatus capable of correcting the curvature of field of a photographic lens by deforming an image capturing plane. This image capturing apparatus deforms the image capturing plane according to the curvature of field by respectively driving a plurality of photoelectric conversion elements. Further, U.S. Pat. No. 5,777,719 discusses an apparatus capable of correcting a distorted wavefront using a deformable mirror. This apparatus deforms the mirror based on a measured value of wave aberration of an eye to thereby correct the aberration.

The image capturing apparatus discussed in Japanese Patent Application Laid-Open No. 2007-208775 needs to include an electric circuit for reading data for the photoelectric conversion elements and a driving unit for deforming the image capturing plane. Further, if the image capturing apparatus is configured to cool the photoelectric conversion elements to reduce noises in image data, this image capturing apparatus also needs to include a cooling mechanism having a temperature adjustment element, an electric circuit, and the like. Therefore, especially if the image capturing apparatus is configured to have a driving unit for each of the photoelectric conversion elements, it is spatially difficult to provide the cooling mechanism for each of the photoelectric conversion elements in addition to the driving unit. Further, a focus adjustment against the unevenness of a sample requires larger deformation of an image capturing plane, but a further larger space is necessary to equip a driving unit enabling sufficient deformation in such configuration.

Further, the apparatus discussed in U.S. Pat. No. 5,777,719 includes a mechanism for adjusting the wavefront, but the adjustment is performed at a pupil position in the optical system, whereby such mechanism cannot be employed in the image acquisition apparatus to correct a defocused state due to unevenness of a sample without any modification. This is because, even if the mechanism discussed in U.S. Pat. No. 5,777,719 is used for a focus adjustment at an image plane position of a sample, a driving amount becomes necessary which is larger than a driving amount at the time of driving of the mirror for an aberration correction. Therefore, the configuration of the apparatus discussed in U.S. Pat. No. 5,777,719 is not sufficient to acquire excellent image data of a whole sample.

### SUMMARY OF THE INVENTION

The present invention is directed to an image acquisition apparatus capable of acquiring excellent image data of a whole sample with a simple structure even if the sample has an uneven surface in a depth direction.

According to an aspect of the present invention, an image acquisition apparatus includes an imaging optical system configured to image an object, a reimaging optical system configured to reimage the object imaged by the imaging optical system, a reflecting member disposed in an optical path between the imaging optical system and the reimaging optical system, an image sensor configured to capture an image of the object reimaged by the reimaging optical system, and to output the image, a first driving unit configured to change a tilt of the reflecting member relative to an optical axis of the imaging optical system, and a correction unit configured to correct a positional deviation of the image in a rotational direction, wherein the positional deviation of the image is generated according to a change in the tilt of the reflecting member.

Further features of the present invention will become apparent from the following description of exemplary embodiments with reference to the attached drawings.

### BRIEF DESCRIPTION OF THE DRAWINGS

FIG. 1 is a schematic view illustrating main components of an image acquisition system according to exemplary embodiments of the present invention.

FIGS. 2A and 2B illustrate a focus adjustment method using a reflecting member according to the exemplary embodiments of the present invention.

FIGS. 3A and 3B are schematic views illustrating main components of driving units for the reflecting member and an image sensor according to the exemplary embodiments of the present invention.

FIGS. 4A and 4B are schematic views illustrating main components of an objective optical system and the vicinity thereof according to a first exemplary embodiment of the present invention.

FIGS. 5A and 5B are schematic views illustrating main components of an objective optical system and the vicinity thereof according to a second exemplary embodiment of the present invention.

### DESCRIPTION OF THE EMBODIMENTS

Exemplary embodiments of the present invention will be described with reference to the drawings.

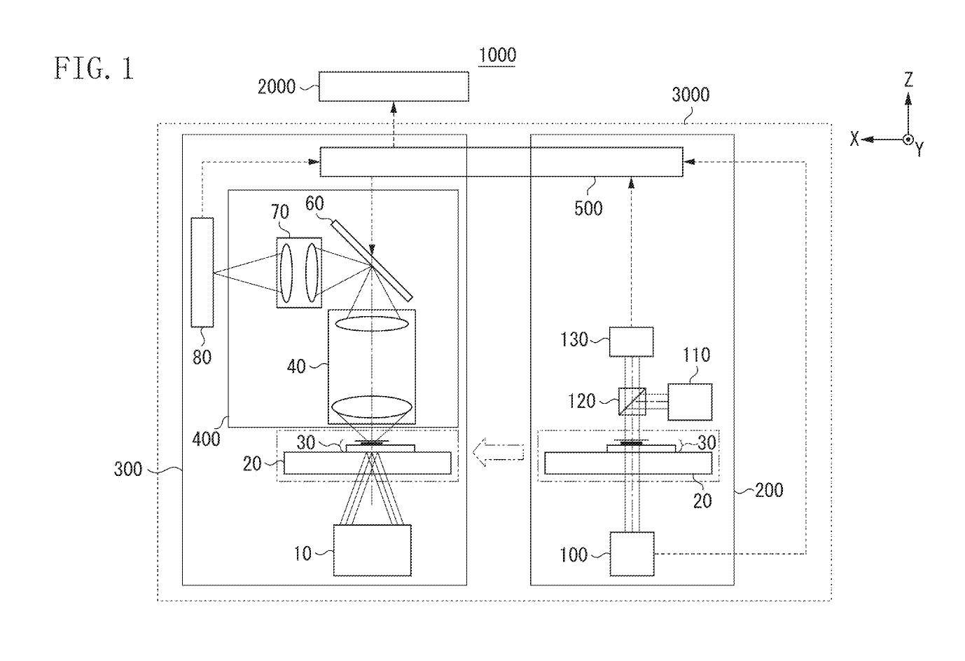

FIG. 1 is a schematic view illustrating main components of an image acquisition system 1000. The image acquisition system 1000 includes an image acquisition apparatus 3000 as a microscopic apparatus configured to acquire an image of a sample, and an image display unit 2000 configured to display the acquired image. The image acquisition apparatus 3000 includes a stage 20 configured to hold a preparation 30 containing the sample, a measurement unit 200 configured to acquire information of the sample, an image capturing unit 300 configured to capture the image of the sample, and a calculation unit 500 configured to control the measurement unit 200 and the image capturing unit 300 and to process the captured image.

The measurement unit 200 includes a positional measurement sensor 100, a measurement light source 110, a beam splitter 120, and a shape measurement sensor 130. Further, the image capturing unit 300 includes an illumination optical system 10, an objective optical system 400, and an image sensor 80. The objective optical system 400 includes an imaging optical system 40, a reflecting member (reflecting mirror) 60, and a reimaging optical system 70. As illustrated in FIG. 1, the stage 20 is configured to be movable between a measurement position in the measurement unit 200 and an image capturing position in the image capturing unit 300.

In the following description, a procedure for acquiring an image by the image acquisition apparatus 3000 according to exemplary embodiments of the present invention will be described. The exemplary embodiments of the present invention will be described assuming that a Z direction is a direction along an optical axis of the imaging optical system 40, a Y direction is a direction perpendicular to the paper surface of the drawing, and an X direction is a direction perpendicular to the Z and Y directions.

First, the preparation 30 containing the sample is placed on the stage 20, and the stage 20 moves to the measurement position in the measurement unit 200 while holding the preparation 30. In the measurement unit 200, a light flux from the measurement light source 110 is deflected by the beam splitter 120, and illuminates the preparation 30. A light flux transmitted through the preparation 30 is incident on the positional measurement sensor 100, which then acquires information such as the size of the sample in the preparation 30 and the position thereof in the X and Y directions. For example, a commercially available charge coupled device (CCD) camera can be used as the positional measurement sensor 100.

On the other hand, a light flux reflected by the preparation 30 is incident on the shape measurement sensor 130 after being transmitted through the beam splitter 120. The shape measurement sensor 130 measures positional information of each XY position on the sample surface in the preparation 30 in the Z direction to acquire the shape information of the sample. For example, a commercially available Shack-Hartmann sensor, an interferometer, and a line sensor can be used as the positional measurement sensor 130. However, the measurement unit 200 is not limited to this configuration. For example, the measurement unit 200 may measure the position and size of the sample, and the surface shape of the sample at different positions by using different light sources.

Then, the sample information (the position, size, and shape of the sample) acquired by the measurement unit 200 is transmitted to the calculation unit 500, and is stored in a memory in the calculation unit 500. After the measurement unit 200 has completed acquiring the sample information, the stage 20 holding the preparation 30 moves from the measurement position in the measurement unit 200 to the image capturing position in the image capturing unit 300.

In the image capturing unit 300, the preparation 30 is evenly illuminated by a light flux emitted from the illumination optical system 10. For example, visible light having a wavelength of 400 nm to 700 nm can be used as the light flux emitted from the illumination optical system 10. Then, the imaging optical system 40 forms an image of the sample near the reflecting member 60 by the light flux transmitted through the sample in the preparation 30. The light flux that forms the image of the sample is reflected on the reflecting member 60 to be deflected out of an optical path of the imaging optical system 40, and is reimaged on an image capturing plane of the image sensor 80 by the reimaging optical system 70.

The reflecting member 60 is configured to be able to change its tilt relative the optical axis of the imaging optical system 40, and this tilt is controlled by the calculation unit 500 according to the shape information of the sample. Further, the image sensor 80 is configured to be rotatable around an optical axis of the reimaging optical system 70 as a rotational axis. The rotational direction and rotational amount of the image sensor 80 is controlled by the calculation unit 500 to correct a positional deviation of the image in the rotational direction according to the change in the tilt of the reflecting member 60. For example, a commercially available rotational stage or gonio stage can be used as a driving unit for the image sensor 80. The image capturing unit 300 can acquire excellent image data in focus as the whole sample by respectively adjusting the tilt of the reflecting member 60 and the position of the image sensor 80 in the rotational direction (the details of which will be described below).

The imaging optical system 40 is not limited to a system that images a light flux only once, and may be configured to form an image of the sample by imaging a light flux a plurality of times. For example, the imaging optical system 40 may be a system that forms an intermediate image in the process of imaging the sample near the reflecting member 60, like a catadioptric system. In other words, the objective optical system 400 according to the exemplary embodiments of the present invention may be configured in any manner as long as a light flux from the sample is eventually imaged near the reflective member 60 by the imaging optical system 40, and the number of times of imaging therefor may be any number. Further, the reimaging optical system 70 can be an enlargement system that reimages the sample while enlarging an image of the sample formed by the imaging optical system 40 at a predetermined lateral magnification.

Then, image data is generated by capturing the image of the sample reimaged on the image capturing plane of the image sensor 80 and processing the output information of the image sensor 80 by the calculation unit 500. To acquire an image of the whole sample, a plurality of pieces of image data is acquired by moving the stage 20 horizontally and capturing an image of the sample a plurality of times (step image capturing), or by capturing an image of the sample while scanning the sample. Then, the calculation unit 500 connects the plurality of pieces of image data, as a result of which a single piece of image data can be generated. The calculation unit 500 performs various kinds of processing according to the purpose, such as a correction of an aberration that cannot be sufficiently corrected by the objective optical system 400, in addition to the above-described processing. The image data acquired by the image capturing unit 300 can be displayed on the image display unit 2000.

In the exemplary embodiments of the present invention, the sample information is acquired by the measurement unit 2000. However, the image acquisition apparatus 3000 may be configured not to include the measurement unit 200. For example, the image acquisition system 1000 may be configured in such a manner that sample information acquired by an external apparatus is transmitted to the calculation unit 500. In this case, the microscopic apparatus may be constituted by the image capturing unit 300 and the calculation unit 500. Further, instead of the calculation unit 500, the image acquisition apparatus 3000 may separately include a control unit for controlling the measurement unit 200 and the image capturing unit 300, and an image processing unit for processing a captured image.

A method for a focus adjustment by changing an imaging position of the imaging optical system 40 by the reflecting member 60 will be described next.

If a sample has an undulating shape (uneven in the Z direction) when the image acquisition apparatus 3000 acquires an image of the sample, the imaging optical system 40 forms an image of each area on the sample at a different position (the imaging position) according to the XY position on the sample. In other words, a flat image plane of the sample cannot be formed by the imaging optical system 40, whereby it is impossible to acquire an image of the whole sample in focus even though the image sensor 80 is disposed within a plane near the image plane of the sample.

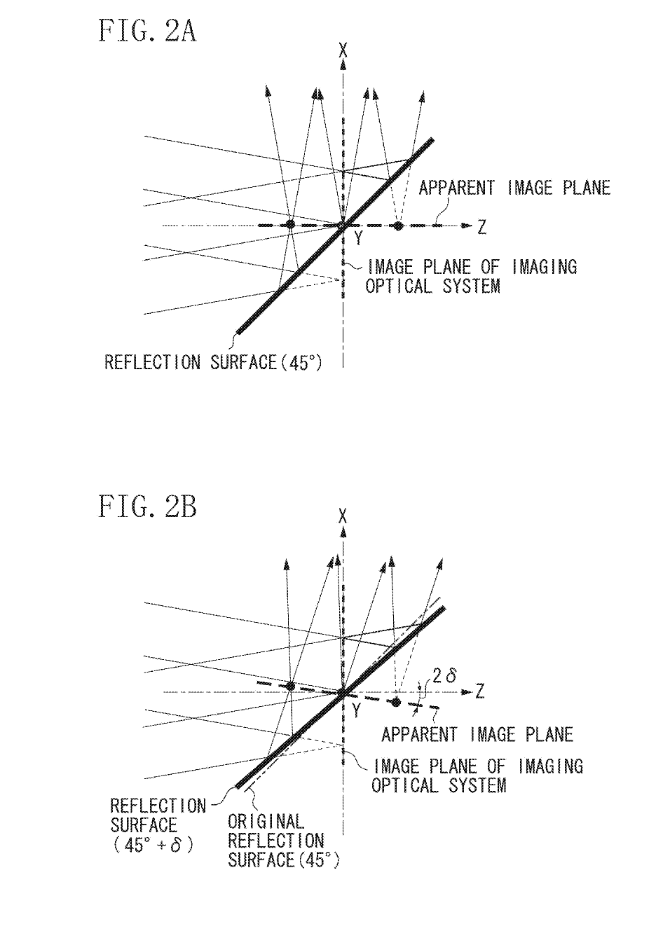

Then, consideration is given to adjusting the imaging position of a light flux from the imaging optical system 40 by changing the tilt of the reflecting member 60. FIGS. 2A and 2B schematically illustrate the positional relationship between the position of an image plane formed by a plurality of imaging points of the imaging optical system 40 and the reflection surface of the reflecting member 60. Now, consideration is given to an effect by changing the tilt of the reflecting member 60 around the axis Y perpendicular to the optical axis Z of the imaging optical system 40 and the optical axis X of the reimaging optical system 70, as a rotational axis. As illustrated in FIG. 2A, if the reflecting member 60 is disposed with its reflection surface tilting at 45 degrees relative to the optical axis Z of the imaging optical system 40, the image plane of the imaging optical system 40 rotates by 90 degrees by the reflecting member 60 to form an apparent image plane. Further, as illustrated in FIG. 2B, if the tilt of the reflection surface changes by an angle of δ degrees around the axis Y as a rotational axis, the tilt of the apparent image plane changes by an angle of 2δ degrees according thereto.

Based on this principle, the reflection surface of the reflecting member 60 can be adjusted to coincide with an intermediate position between the image plane position of the imaging optical system 40 and the object position of the reimaging optical system 70 by changing the tilt of the reflecting member 60. As a result, the position of the apparent image plane of the imaging optical system 40 can coincide with the object position of the reimaging optical system 70, whereby a reimaged image of the sample can be formed on the image capturing plane of the image sensor 80. Therefore, for example, at the time of step image capturing, the above-described focus adjustment is performed for each step, by which it is possible to acquire an image of the whole sample in focus.

As described above, FIGS. 2A and 2B illustrate the example in which the apparent image plane tilts relative to the optical axis X of the reimaging optical system 70 from the state perpendicular to the optical axis X of the reimaging optical system 70, and the description about it has been provided above. However, actually, the tilt of the apparent image plane relative to the optical axis X of the reimaging optical system 70 is generated before the change in the tilt of the reflecting member 60, due to the unevenness of the surface of the sample. Therefore, at the time of actual image capturing, contrary to the description about FIGS. 2A and 2B, the tilt of the reflecting member 60 is adjusted in such a manner that the apparent image plane becomes perpendicular to the optical axis X of the reimaging optical system 70. A change in the tilt of the reflecting member 60 leads to a change in the traveling direction of a light flux reflected by the reflection surface of the reflecting member 60. This can be dealt with by sufficiently increasing the NA of the reimaging optical system 70 in such a manner that the light flux is contained within the optical path of the reimaging optical system 70.

As described above, if the sample is uneven in the Z direction, the surface shape varies depending on the XY position, whereby it is necessary to appropriately set the direction and amount of the tilt of the reflecting member 60 according to the XY position on the surface of the sample to perform an excellent focus adjustment over the whole sample. For example, when step image capturing is performed by horizontally moving the stage 20 to acquire an image of the whole sample, it is necessary to set the direction and amount of the tilt of the reflecting member 60 based on the shape information of the sample for each step. At this time, the setting requires not only the adjustment of the tilt of the reflecting member 60 around the axis Y, which is perpendicular to the optical axis Z of the imaging optical system 40 and the optical axis X of the reimaging optical system 70, as a rotational axis described with reference to FIGS. 2A and 2B, but also an adjustment of the tilt around the axes other than the axis Y as rotational axes.

However, if the tilt of the reflecting member 60 changes around another axis than the axis Y as a rotational axis, the change causes a rotation (a positional deviation in a rotational direction) of an image around the optical axis X of the reimaging optical system 70 on the image capturing plane of the image sensor 80. Then, the rotational direction and amount when an image rotates varies depending on the tilt direction and amount of the reflecting member 60. As a result, an image of each area on the sample rotates in a different direction and by a different amount for each step, whereby it becomes difficult to connect the plurality of acquired images to generate a single piece of image data.

Therefore, the image acquisition apparatus 3000 according to the exemplary embodiments of the present invention is configured to be able to correct a positional deviation of an image in the rotational direction which is generated according to a change in the tilt of the reflecting member 60. More specifically, the image acquisition apparatus 3000 includes a driving unit for rotating the image sensor 80 around the optical axis X of the reimaging optical system 70 as a rotational axis, and uses this driving unit and the calculation unit 500 as a correction unit. The image acquisition apparatus 3000 controls the rotational direction and amount of the image sensor 80 by the correction unit. When performing a focus adjustment by changing the tilt of the reflecting member 60 around another axis than the axis Y as a rotational axis, the image acquisition apparatus 3000 can correct an image rotation generated from the adjustment by this control by the correction unit. Therefore, the image acquisition apparatus 3000 can generate excellent image data, in which the whole sample is in focus, by connecting a plurality of pieces of image data acquired by capturing images of the respective areas on the sample. In the exemplary embodiments of the present invention, the correction unit is constituted by the driving unit for the image sensor 80 and the calculation unit 500. However, the correction unit may be constituted only by the calculation unit 500, and a positional deviation of an image in the rotational direction may be corrected by image processing (the details of which will be described below).

As illustrated in FIG. 1, the image acquisition apparatus 3000 has been described based on the example that includes the single reflecting member 60, the single reimaging optical system 70, and the single image sensor 80. However, the exemplary embodiments of the present invention are not limited thereto. In other words, the image acquisition apparatus 3000 may be configured to include a plurality of reflecting members 60, a plurality of reimaging optical systems 70, and a plurality of image sensors 80. According to such configuration, it is possible to adjust the imaging positions of respective light fluxes from the imaging optical system 40 by changing the tilts of the respective ones of the plurality of reflecting members 60. In other words, it is possible to make such an adjustment that the respective imaging positions of the imaging optical system 40 coincide with the object positions of the respective corresponding ones of the plurality of reimaging optical systems 70, and the reimaging positions of the respective ones of the plurality of reimaging optical systems 70 coincide with the imaging planes of the respective corresponding ones of the plurality of image sensors 80.

At this time, the tilt directions and amounts of the respective ones of the plurality of reflecting members 60 are individually set for each of the reflecting members 60 based on the shape information of the sample, whereby the output images have different rotational directions and different rotational amounts for each of the plurality of image sensors 80. Therefore, the respective ones of the plurality of image sensors 80 are rotated around the optical axes of the respective corresponding reimaging optical systems 70 as rotational axes, by which it is possible to correct positional deviations of images in the rotational direction according to changes in the tilts of the respective corresponding reflecting members 60. In this manner, according to the configuration that includes the plurality of reflecting members 60, the plurality of reimaging optical systems 70, and the plurality of image sensors 80, it is possible to adjust the focusing state for more areas at one time, and to capture images of more areas by one image capturing operation.

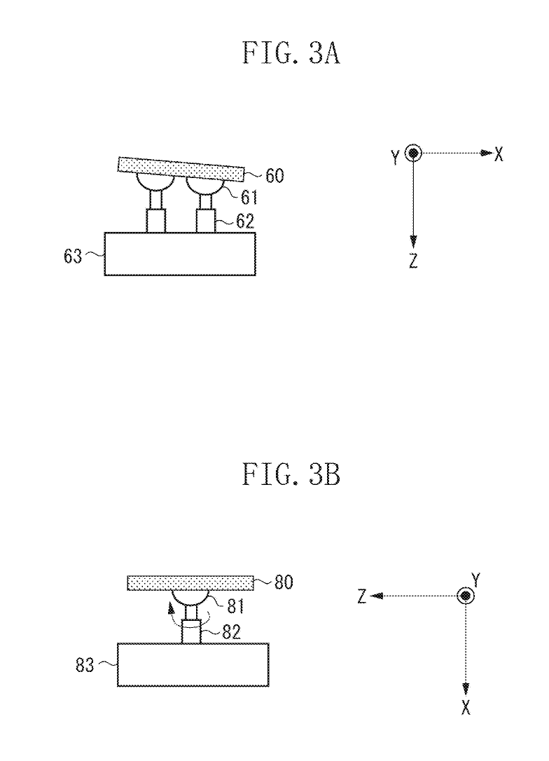

FIGS. 3A and 3B illustrate a driving unit (a first driving unit) for the reflecting member 60 and the driving unit (a second driving unit) for the image sensor 80, respectively. As illustrated in FIG. 3A, the first driving unit includes connection members 61, cylinders 62, and a surface plate 63. According to the exemplary embodiments of the present invention, three connection members 61 and three cylinders 62 are provided to the reflecting member 60, and FIG. 3A illustrates only two of the three connection members 61 and two of the three cylinders 62 that are located on the front side as viewed in the paper surface of the drawing. The first driving unit is controlled to change the lengths of the respective cylinders 62, and thereby the tilt of the reflecting member 60 can change freely. Further, as illustrated in FIG. 3B, the image sensor 80 is provided with the second driving unit (a rotational mechanism) including a connection member 81, a cylinder 82, and a surface plate 83, whereby the image sensor 80 can be configured to be rotatable around the axis X as a rotational axis.

The image acquisition apparatus 3000 is configured in such a manner that the plurality of reflecting members 60 deflects a plurality of light fluxes from the imaging optical system 40 in different directions, respectively, which allows the respective ones of the plurality of image sensors 80 to be dispersedly disposed in planes different from one another. As a result, an enough space can be generated among the image sensors 80 to allow the driving units, temperature adjustment mechanisms, and the like to be desirably arranged for the respective ones of the plurality of image sensors 80, whereby it is possible to realize simplification of the apparatus.

The objective optical system 400 according to the exemplary embodiments of the present invention is configured in such a manner that the reflecting member 60 is disposed in the optical path between the imaging optical system 40 and the reimaging optical system 70, and a light flux imaged by the imaging optical system 40 is reflected by the reflecting member 60 to be reimaged via the reimaging optical system 70. If the reimaging optical system 70 is an enlargement system having a predetermined lateral magnification, a sample image formed by the imaging optical system 40 is reimaged while being enlarged at the lateral magnification. Further, when a certain object point is displaced in the optical axis direction relative to the reimaging optical system 70, the displacement amount of the corresponding image point increases according to the longitudinal magnification (the square of the lateral magnification). Therefore, if the imaging position of the imaging optical system 40 is displaced by driving the reflecting member 60, the displacement amount thereof increases at the longitudinal magnification of the reimaging optical system 70, and the reimaging position is displaced by a larger displacement amount. In other words, use of an enlargement system as the reimaging optical system 70 can realize an effective focus adjustment even with a small displacement amount of the reflecting member 60.

In this manner, according to the image acquisition apparatus 3000 of the exemplary embodiments of the present invention, it is possible to adjust the tilt of the reflecting member 60 relative to the optical axis of the imaging optical system 40 based on the shape information of a sample. Further, it is possible to adjust the position of the image sensor 80 in the rotational direction to correct a positional deviation of an image in the rotational direction according to the change in the tilt of the reflecting member 60. As a result, it is possible to acquire excellent image data in which the whole sample is in focus with a simple configuration.

Hereinafter, the respective exemplary embodiments of the image acquisition apparatus 3000 according to the present invention will be described in detail.

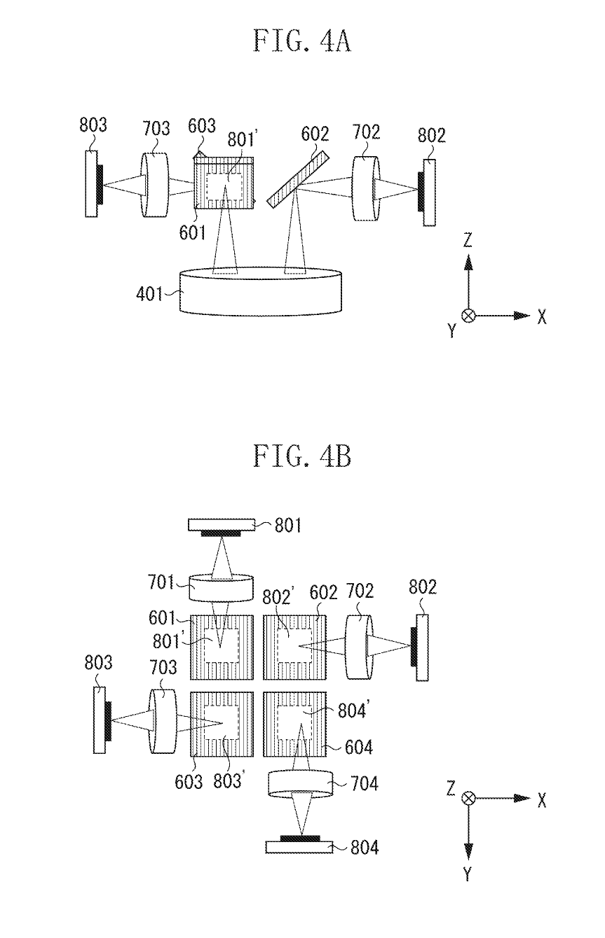

In the following description, a first exemplary embodiment will be described. FIGS. 4A and 4B are schematic views illustrating main components at and around an objective optical system included in the image acquisition apparatus 3000 according to the first exemplary embodiment. FIG. 4A is a schematic view illustrating the objective optical system as viewed from the −Y direction toward the +Y direction. FIG. 4B is a schematic view illustrating the objective optical system as viewed from the -Z direction toward the +Z direction. The objective optical system according to the present exemplary embodiment includes an imaging optical system 401, reflecting members 601 to 604, and reimaging optical systems 701 to 704. Further, ranges 801′ to 804′ indicated by broken lines indicate ranges on the reflecting members 601 to 604 corresponding to light-receiving areas of the respective image sensors 801 to 804. For convenience of illustration, FIG. 4A illustrates the reflecting members 601 to 604, the reimaging optical systems 701 to 704, and the image sensors 801 to 804 with a part of them omitted therefrom, and FIG. 4B illustrates them with the tilts of the respective reflecting members 601 to 604 and the imaging optical system 401 omitted therefrom.

At this time, as illustrated in FIGS. 4A and 4B, the respective reflecting members 601 to 604 are disposed to deflect respective light fluxes from the imaging optical system 401 in different directions, and the respective ones of the plurality of image sensors 801 to 804 are dispersedly disposed in planes different from one another. Then, the respective light fluxes reflected by the respective reflecting members 601 to 604 can be reimaged on the image capturing planes of the respective corresponding image sensors 801 to 804 by the respective corresponding reimaging optical systems 701 to 704. The objective optical system is configured in this manner, by which an enough space can be generated among the respective image sensors 801 to 804 to allow the driving units, the temperature adjustment mechanisms, and the like to be more desirably arranged for the respective image sensors 801 to 804.

An image capturing operation by the image acquisition apparatus 3000 according to the present exemplary embodiment will be described specifically. Respective light fluxes from a sample in the preparation 30 pass through the imaging optical system 401, and form images near the respective reflecting members 601 to 604. Then, the light fluxes that form the images of the sample are reflected by the respective reflecting members 601 to 604 to be deflected out of the optical path of the imaging optical system 401. The respective deflected light fluxes are reimaged on the image capturing planes of the respective image sensors 801 to 804 by the respective reimaging optical systems 701 to 704.

A focus adjustment is performed in such a manner that the images of the sample reimaged by the respective reimaging optical systems 701 to 704 coincide with the image capturing planes of the respective image sensors 801 to 804. More specifically, the not-illustrated driving units are controlled by the calculation unit 500 based on the shape information of the sample, thereby changing the tilts of the respective reflecting members 601 to 604. Further, the not-illustrated driving units are controlled by the calculation unit 500 based on the changes in the tilts of the respective corresponding reflecting members 601 to 604, thereby rotating the respective image sensors 801 to 804 around the optical axes of the respective corresponding reimaging optical systems 701 to 704 as rotational axes. In this manner, the reflecting members 601 to 604 and the image sensors 801 to 804 are adjusted, by which it is possible to acquire image data, in which images are in focus and the positional deviations in the rotational direction are corrected, at the respective image sensors 801 to 804.

According to the image acquisition apparatus 3000 of the present exemplary embodiment, the plurality of image sensors 801 to 804 is disposed, which makes it possible to acquire image data in focus with a wider area by one image capturing operation. However, if there is generated any area (gaps between the ranges 801′ to 804′) that cannot be imaged by one image capturing operation of the image sensors 801 to 804, this also leads to generation of gaps in the acquired image data. Therefore, the present exemplary embodiment captures an image of the sample step by step while moving the position of the stage 20 (not illustrated), which holds the sample, in the X and Y directions to cover areas that cannot be imaged. At this time, the tilts of the respective reflecting members 601 to 604 are changed into different tilts for each step based on the shape information of the sample. Further, the positions of the respective corresponding image sensors 801 to 804 in the rotational direction based on the optical axes of the respective corresponding reimaging optical systems 701 to 704 as rotational axes are displaced to different positions for each step based on the changes in the tilts of the respective reflecting members 601 to 604. Then, the image data pieces acquired by the respective steps are connected by the calculation unit 500, by which it is possible to generate a single image data piece, in which the whole sample is in focus and no gap is generated.

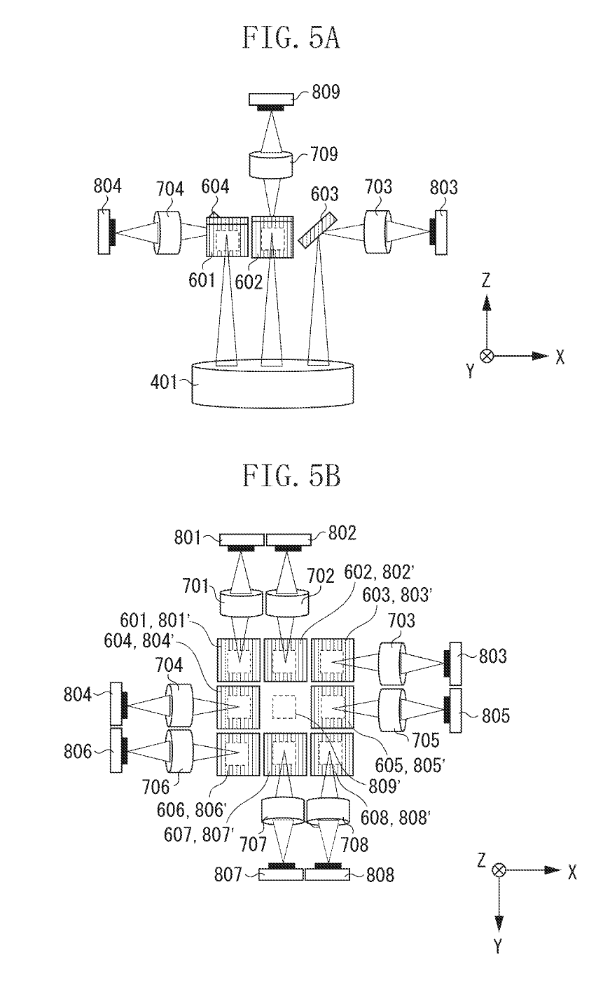

Next, a second exemplary embodiment will be described. FIGS. 5A and 5B are schematic views illustrating main components at and around an objective optical system included in the image acquisition apparatus 3000 according to the second exemplary embodiment. FIG. 5A is a schematic view illustrating the objective optical system as viewed from the −Y direction toward the +Y direction. FIG. 5B is a schematic view illustrating the objective optical system as viewed from the −Z direction toward the +Z direction. Similar or corresponding components to the first exemplary embodiment will be identified by the same reference numerals, and will be described briefly or not described repeatedly. The objective optical system according to the present exemplary embodiment includes the imaging optical system 401, reflecting members 601 to 608, and reimaging optical systems 701 to 709, and the present exemplary embodiment is configured to form images on the respective image sensors 801 to 809 by the objective optical system. In other words, the present exemplary embodiment is configured to include more reflecting members, more reimaging optical systems, and more image sensors than the first exemplary embodiment. A range 809′ indicates a range corresponding to the light-receiving area of the image sensor 809 at an opening portion surrounded by the reflecting members 601 to 608.

At this time, as illustrated in FIGS. 5A and 5B, the respective reflecting members 601 to 608 are disposed to deflect light fluxes from the imaging optical system 401 in a plurality of directions, and the respective ones of the plurality of image sensors 801 to 809 are dispersedly disposed in a plurality of different planes. Then, the respective light fluxes reflected by the respective reflecting members 601 to 608 can be reimaged on the image capturing planes of the respective corresponding image sensors 801 to 808 by the respective corresponding reimaging optical systems 701 to 708. The present exemplary embodiment is configured in this manner, by which an enough space can be generated among the respective image sensors 801 to 809 to allow the driving units, the temperature adjustment mechanisms, and the like to be more desirably arranged for the respective image sensors 801 to 809.

An image capturing operation by the image acquisition apparatus 3000 according to the present exemplary embodiment will be described specifically. Among the light fluxes from the sample in the preparation 30, respective light fluxes incident on the ranges 801′ to 808′ pass through the imaging optical system 401, and form images near the respective reflecting members 601 to 608. Further, among the light fluxes from the sample, a light flux incident on the range 809′ is imaged near the opening surrounded by the reflecting members 601 to 608. At this time, at least one of the position and tilt of the stage 20 (not illustrated) that holds the sample is adjusted in such a manner that the light flux incident on the range 809′ is imaged on the image capturing plane of the image sensor 809. The present exemplary embodiment adjusts at least one of the position of the stage 20 in the optical axis direction (the Z direction) of the imaging optical system 401 and the tilt of the stage 20 relative to the optical axis of the imaging optical system 401. At this time, the optimum tilt of the stage 20 is calculated by, for example, the least-square method based on the shape of the sample acquired by the measurement unit 200.

Then, the stage 20 is fixed at the position, and the tilts of the respective reflecting members 601 to 608 are adjusted relative to the optical axis of the imaging optical system 401 based on the shape information of the sample. As a result, it is possible to make an adjustment in such a manner that the images of the sample reimaged by the respective reimaging optical systems 701 to 708 coincide with the image capturing planes of the respective image sensors 801 to 808. Further, the positions of the respective image sensors 801 to 808 in the rotational direction are adjusted around the optical axes of the respective corresponding reimaging optical systems 701 to 708 as rotational axes based on the changes in the tilts of the respective corresponding reflecting members 601 to 608 by the calculation unit 500 and the not-illustrated driving units. As a result, it becomes possible to acquire image data in which the images are in focus, and the positional deviations in the rotational direction are corrected at the respective image sensors 801 to 809.

In this manner, according to the image acquisition apparatus 3000 of the present exemplary embodiment, the plurality of image sensors 801 to 809 is disposed, which makes it possible to acquire image data in focus with a wider area by one image capturing operation, compared to the first exemplary embodiment. For areas that cannot be imaged by one image capturing operation, it is possible to acquire image data of the whole sample by capturing an image of the sample step by step while moving the position of the stage 20 that holds the sample in the X and Y directions in a similar manner to the first exemplary embodiment.

In the following description, a third exemplary embodiment will be described. The image acquisition apparatus 3000 according to the third exemplary embodiment includes an objective optical system configured in a similar manner to the first exemplary embodiment illustrated in FIGS. 4A and 4B, but differs from the first exemplary embodiment in a lack of the driving units for rotating the respective image sensors 801 to 804.

The present exemplary embodiment also performs a focus adjustment by changing the tilts of the respective reflecting members 601 to 604 relative to the optical axis of the imaging optical system 401 in a similar manner to the first exemplary embodiment. However, the present exemplary embodiment corrects the positional deviations of the images in the rotational direction, which are generated due to the changes in the tilts of the respective reflecting members 601 to 604, by image processing of the image data, instead of the control for rotating the image sensors 801 to 804. More specifically, the present exemplary embodiment performs processing for correcting, in the rotational direction, the positions of the image data pieces acquired by the respective corresponding image sensors 801 to 804 by the not-illustrated calculation unit 500 based on the changes in the tilts of the respective reflecting members 601 to 604. By the processing, it becomes possible to acquire image data in which the images are in focus, and the positional deviations in the rotational direction are corrected at the respective image sensors 801 to 804.

For areas that cannot be imaged by one image capturing operation, the present exemplary embodiment can also acquire image data of the whole sample by capturing an image of the sample step by step while moving the position of the stage 20 that holds the sample in the X and Y directions in a similar manner to the first exemplary embodiment.

In this manner, according to the image acquisition apparatus 3000 of the present exemplary embodiment, it is possible to generate image data in which a whole sample is in focus by adjusting the tilts of the reflecting members 601 to 604 and by the calculation unit 500 correcting the positional deviations of the image data pieces in the rotational direction. The present exemplary embodiment eliminates the necessity of the driving units for rotating the respective image sensors 801 to 804, thereby allowing an electric circuit for reading out data from each of the image sensors 801 to 804, a cooling mechanism (a temperature adjustment element), and the like to be easily arranged.

In the following description, other exemplary embodiments will be described.

For example, at least one of the reflecting member 60 and the image sensor 80 may be configured to be displaceable in the optical axis direction of the corresponding reimaging optical system 70. As a result, it is possible to perform a focus adjustment by driving the respective reflecting member 60 and image sensor 80 in the optical axis direction of the corresponding reimaging optical system 70 if the uneven shape of the sample cannot be dealt with only by adjusting the tilt of the reflecting member 60. When step image capturing is performed using only one image sensor 80, a focus adjustment may be performed by driving the stage 20, which holds the sample, in the optical axis direction of the reimaging optical system 70 for each step.

Further, in the configuration that includes a plurality of image sensors 80, the number and arrangement of image sensors 80 are appropriately determined according to the shape and size of a sample. Therefore, it is possible to perform a focus adjustment in a similar manner to the above-described respective exemplary embodiments by disposing the reimaging optical systems 70 and the reflecting members 60 according to the arrangement of the respective image sensors 80. Regardless of the number and arrangement of the image sensors 80, the image acquisition apparatus 3000 may be configured to include a single image sensor 80 that receives a light flux, which does not pass through the reflecting member 60, in a similar manner to the second exemplary embodiment. In this case, it is possible to bring images into focus on all of the image sensors 80 by adjusting the tilts of the reflecting members 60 corresponding to the other image sensors 80 based on the position where an image can be in focus on the image capturing plane of the single image sensor 80.

The second exemplary embodiment is configured in such a manner that the light flux imaged at the opening surrounded by the respective reflecting members 601 to 608 is reimaged on the image capturing plane of the single image sensor 809 by the reimaging optical system 709. However, the second exemplary embodiment may be configured in such a manner that the image sensor 809 is disposed at the position of this opening. It is possible to form an image on the image capturing plane of the image sensor 809 even without providing the reimaging optical system 709, by disposing the image sensor 809 at the opening position.

Further, the respective exemplary embodiments realize a correction of the positional deviations of the images in the rotational direction by means of either the correction unit based on the adjustment of the positions of the respective image sensors 801 to 804 or 801 to 809 in the rotational direction using the driving units and the calculation unit 500, or the correction unit based on the image processing by the calculation unit 500. However, the respective correction units may be combined. For example, if the image acquisition apparatus 3000 is configured to include only a single image sensor 80, the image acquisition apparatus 3000 may switch the correction method between the rotational adjustment of the image sensor 80 and the image processing for each step. On the other hand, if the image acquisition apparatus 3000 is configured to include a plurality of image sensors 80, the image acquisition apparatus 3000 may deal with the correction by the image processing without performing the rotational adjustment for a part of the image sensors 80 (without providing the driving units therefor).

The first and second exemplary embodiments rotate the image sensors 801 to 804 or 801 to 809 around the optical axes of the corresponding reimaging optical systems 701 to 704 or 701 to 709 as rotational axes, by the calculation unit 500 controlling the driving units of the corresponding image sensors 801 to 804 or 801 to 809 based on the changes in the tilts of the reflecting members 601 to 604 or 601 to 608. At this time, by including a reflecting member measurement unit for acquiring the changes in the tilts (tilt information) of the reflecting members 601 to 604 or 601 to 608, the image acquisition apparatus 3000 can rotate the image sensors 801 to 804 or 801 to 809 based on this tilt information. Similarly, the image acquisition apparatus 3000 according to the third exemplary embodiment can also be configured to be able to acquire the tilt information of the reflecting members 601 to 604 by including the reflecting member measurement unit. As a result, the image acquisition apparatus 3000 can perform the processing for correcting the positions of the image data pieces acquired by the corresponding image sensors 801 to 804 or 801 to 809 in the rotational direction, by the calculation unit 500 based on the tilt information of the reflecting members 601 to 604 or 601 to 608.

However, the image acquisition apparatus 3000 according to the exemplary embodiments of the present invention may be configured not to include the reflecting member measurement unit and not to acquire the tilt information of the reflecting members 601 to 604 or 601 to 608. For example, in the first exemplary embodiment and the second exemplary embodiment, the image acquisition apparatus 3000 may control the driving units by the calculation unit 500 in such a manner that the image sensors 801 to 804 or 801 to 809 are driven according to the changes in the tilts of the reflecting members 601 to 604 or 601 to 608. In this case, this control can be realized by acquiring, in advance, the relationship between the amounts of changes in the tilts of the reflecting members 601 to 604 or 601 to 608, and the rotational amounts and directions of the image sensors 801 to 804 or 801 to 809 required to correct the positional deviations of the images to be generated in the rotational direction. This allows the positional deviations of the images in the rotational direction to be corrected, according to the changes in the tilts of the reflecting members 601 to 604 or 601 to 608, by the correction unit (the calculation unit 500 and the driving units) even without acquiring the tilt information of the reflecting members 601 to 604 or 601 to 608. Similarly, if the image acquisition apparatus 3000 according to the third exemplary embodiment is configured not to have the reflecting member measurement unit, the correction can be realized by acquiring the relationship between the amounts of changes in the tilts of the reflecting members 601 to 604, and image processing amounts required to correct the positional deviations of the images to be generated in the rotational direction in advance. This allows the positional deviations of the images in the rotational direction to be corrected, according to the changes in the tilts of the reflecting members 601 to 604, by the correction unit (the calculation unit 500) even without acquiring the tilt information of the reflecting members 601 to 604.

The respective exemplary embodiments perform step image capturing when capturing an image of a whole sample, but the exemplary embodiments of the present invention can be employed even for a configuration that scans a whole sample. Further, the image acquisition apparatus according to the exemplary embodiments of the present invention is useful not only as a microscopic apparatus that observes an enlarged sample using a whole objective optical system as an enlargement system, but also as, for example, an inspection apparatus that performs an appearance inspection (for example, an inspection about attachment of a foreign substance, and an inspection of a scratch) of a substrate or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-169758 filed Jul. 31, 2012, which is hereby incorporated by reference herein in its entirety.

What is claimed is:

1. An image acquisition apparatus comprising:
an imaging optical system configured to image an object;
a reimaging optical system configured to reimage the object imaged by the imaging optical system;
a reflecting member disposed in an optical path between the imaging optical system and the reimaging optical system;
an image sensor configured to capture an image of the object reimaged by the reimaging optical system, and to output the image;
a first driving unit configured to change a tilt of the reflecting member relative to an optical axis of the imaging optical system; and
a correction unit configured to correct a positional deviation of the image in a rotational direction, wherein the positional deviation of the image is generated according to a change in the tilt of the reflecting member.

2. The image acquisition apparatus according to claim 1, further comprising a calculation unit configured to control the first driving unit based on shape information of the object.

3. The image acquisition apparatus according to claim 1, wherein the correction unit includes
a second driving unit configured to rotate the image sensor around an optical axis of the reimaging optical system as a rotational axis, and
a calculation unit configured to control the second driving unit to correct the positional deviation of the image in the rotational direction.

4. The image acquisition apparatus according to claim 1, wherein the correction unit includes an image processing unit configured to process the image to correct the positional deviation of the image in the rotational direction.

5. The image acquisition apparatus according to claim 1, wherein the correction unit corrects the positional deviation of the image in the rotational direction based on the change in the tilt of the reflecting member.

6. The image acquisition apparatus according to claim 2, further comprising a measurement unit configured to acquire the shape information of the object.

7. The image acquisition apparatus according to claim 1, wherein the reimaging optical system is an enlargement system.

8. The image acquisition apparatus according to claim 1, wherein the reimaging optical system includes a plurality of reimaging optical systems, the reflecting member includes a plurality of reflecting members, and the image sensor includes a plurality of image sensors,
wherein respective ones of the plurality of reimaging optical systems reimage the object on image capturing planes of respective corresponding ones of the plurality of image sensors by light fluxes reflected by respective corresponding ones of the plurality of reflecting members, and
wherein the correction unit corrects positional deviations of respective corresponding ones of a plurality of images in the rotational direction which are generated according to changes in tilts of the respective ones of the plurality of reflecting members relative to the optical axis of the imaging optical system.

9. The image acquisition apparatus according to claim 1, wherein the image acquisition apparatus is a microscope, and the imaging optical system and the reimaging optical system form an enlargement system.

10. An image acquisition system comprising:
an image acquisition apparatus including:
an imaging optical system configured to image an object,
a reimaging optical system configured
to reimage the object imaged by the imaging optical system, a reflecting member disposed in an optical path between the imaging optical system and the reimaging optical system,
an image sensor configured to capture an image of the object reimaged by the reimaging optical system, and to output the image,
a first driving unit configured to change a tilt of the reflecting member relative to an optical axis of the imaging optical system, and
a correction unit configured to correct a positional deviation of the image in a rotational direction, wherein the positional deviation of the image is generated according to a change in the tilt of the reflecting member; and
an image display unit configured to display image data of the object acquired by the image acquisition apparatus.
